(19) United States
(12) Patent Application Publication
(10) Pub. No.: US 2004/0006521 A1
(43) Pub. Date: Jan. 8, 2004

(54) Method and system for locating, acquiring, financing and insuring property

(75) Inventors: Alice Diamant, Castroville, TX (US); Luther Branham, Fair Oaks Ranch, TX (US); Maria Cavazos, San Antonio, TX (US)

Correspondence Address: HAYNES AND BOONE, LLP, 901 MAIN STREET, SUITE 3100, DALLAS, TX, 75202, US

(73) Assignee: United Services Automobile Association, San Antonio, TX

(21) Appl. No.: 10/454,936

(22) Filed: Jun. 5, 2003

Related U.S. Application Data
(60) Provisional application No. 60/390,171, filed on Jun. 20, 2002.

(51) Int. Cl. G06F 17/60

(52) U.S. Cl. 705/35; 705/4

(57) ABSTRACT

A method of selecting, acquiring, financing and insuring property with the assistance of an organization includes a customer communicating with the organization for assistance in selecting a property item. The customer further communicates with the organization for being financed for the property item by the organization. In addition, the customer communicates with the organization for being insured for the property item by the organization.

### BACKGROUND

The disclosures herein relate generally to acquiring and protecting property and in particular, to a method of locating, acquiring, financing and insuring property.

The purchase of major property items such as real estate and automobiles is very time consuming and requires coordinated inquiries with regard to locating the desired property, acquiring and financing the property, and insuring the property. Typically, the search for the property is initiated by a potential buyer, alone or with assistance. A bank or financial institution is then approached to look at qualifying is and financing the potential buyer. An insurance company is also approached to inquire about rates, either as a newly insured or as an add-on.

All of the foregoing requires vast amounts of time on-line, on a phone, via fax or in-person consultations.

It would be advantageous to be able to accomplish each step of this process dealing with only one party, or organization, capable of providing all of the buyers needs, thus obviating the need to coordinate with multiple parties.

### SUMMARY

One embodiment, accordingly, provides a method of acquiring property with the assistance of a single source. A user communicates with an assisting party for assistance in selecting a property item. The assisting party also finances and insures the property item.

A principal advantage of this embodiment is that the assisting party is a financier and insurer of the property item in addition to helping the buyer locate and select the property item.

### BRIEF DESCRIPTION OF THE DRAWINGS

FIG. 1 is a diagrammatic view illustrating a known scenario for purchasing, financing and insuring a major property item.

FIG. 2 is a diagrammatic view illustrating an embodiment of a method of acquiring, financing and insuring a major property item.

FIG. 3 is a chart view illustrating an embodiment of a method of acquiring, financing and insuring a vehicle.

FIG. 4 is a chart view illustrating an embodiment of a method of acquiring, financing and insuring a home.

FIG. 5 is a diagrammatic view illustrating an embodiment of a system for acquiring property via the Internet.

FIG. 6 is an embodiment of a screen shot for a website to assist a user in buying, financing and insuring an automobile vehicle.

FIG. 7 is a flow chart illustrating steps in a method of buying, financing and insuring the vehicle.

FIG. 8 is an embodiment of a screen shot for a website to assist a user in buying, financing and insuring a home.

FIG. 9 is a flow chart illustrating steps in a method of buying, financing and insuring the home.

### DETAILED DESCRIPTION

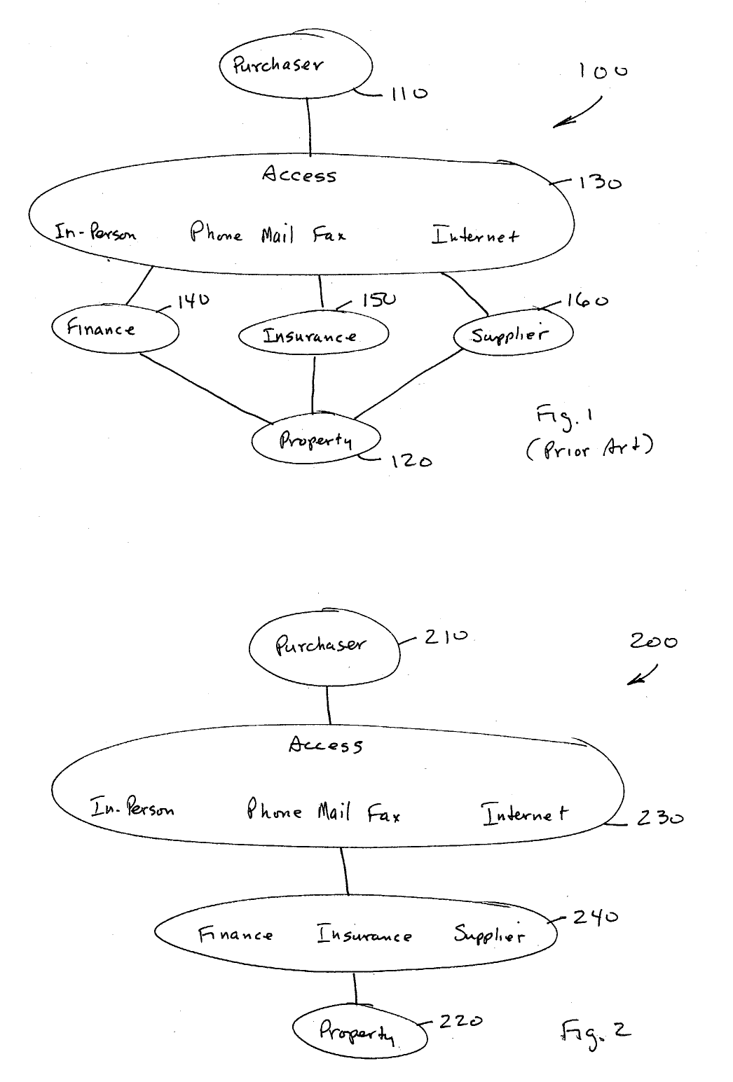

Present day purchasing of a major property item, FIG. 1, includes a system 100 requiring that a purchaser 110 intending to buy property 120, may do so by accessing information at 130, in person, by phone, fax, mail or on-line on the Internet. The purchaser 110 must also access information from a financing source at 140, an insurance source at 150 and a supplier of the property at 160.

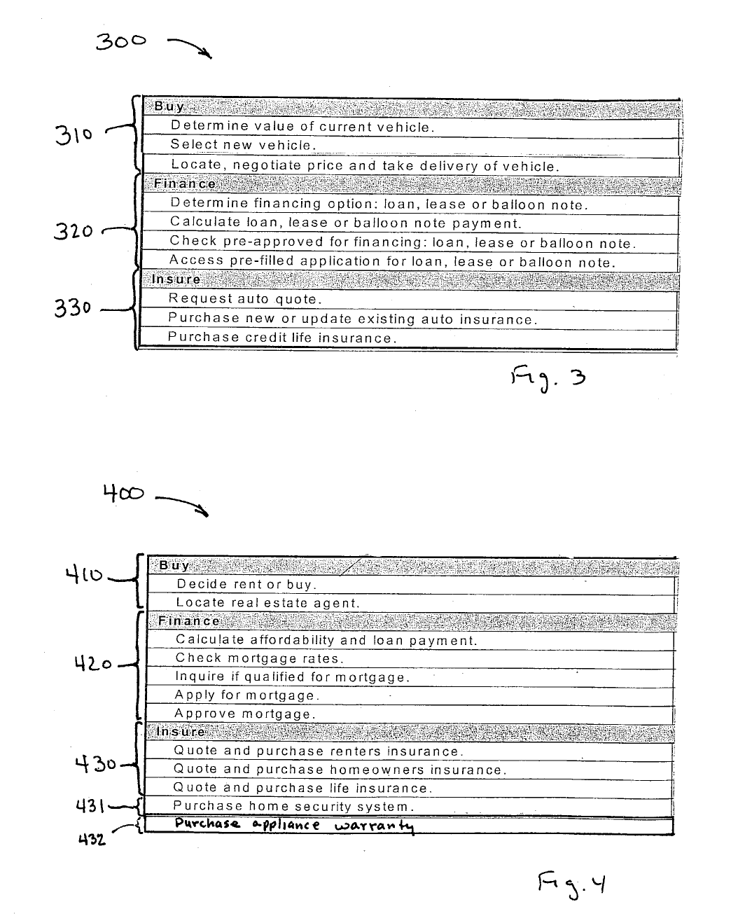

A more ideal situation provides for purchasing a property item, FIG. 2, through a system 200, wherein a purchaser 210 intending to buy property 220, may do so by accessing information at 230, also in person, by phone, fax, mail or on-line on the Internet. This can be accomplished with the assistance of a single source 240 which may be an organization providing assistance in selecting, acquiring, financing and insuring the property 220. That is, the single source 240, which may also be a membership organization, assists in the selection and acquisition of the property from a supplier, and also becomes the financier and insurer of the property 220.

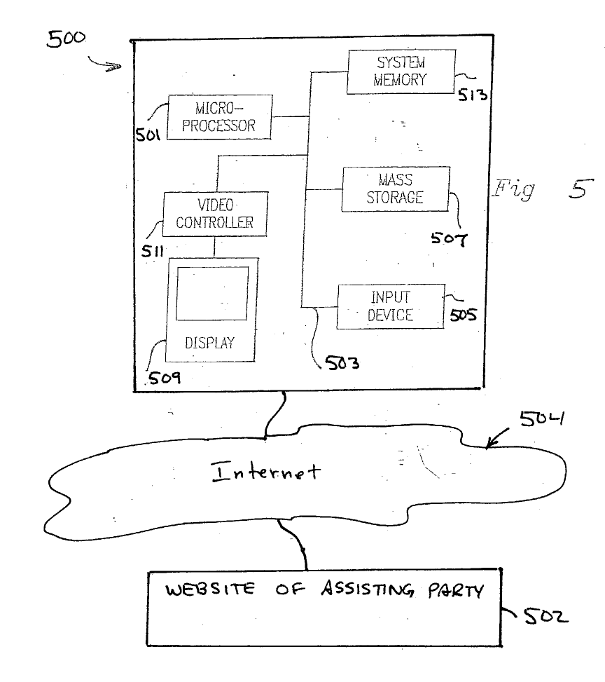

In the instance where the property item is an automobile, FIG. 3, the single source, at 300, acts as an assisting party in the buying 310, financing 320 and insuring 330, phases of an acquisition. During the buying phase 310, the assisting party assists the purchaser in determining the value of any current vehicle that may be available for trade-in purposes. The assisting party assists the purchaser in the selection of a new vehicle, in the location of that vehicle, and the price negotiation for that vehicle right up to taking delivery of that vehicle.

During the financing phase 320, the assisting party assists the purchaser in determining and calculating financing options such as a loan, a lease or a balloon note. The assisting party assists the purchaser in the application process and pre-approval for the loan, lease or balloon note options.

During the insuring phase 330, the assisting party assists the purchaser in determining an insurance quote for a selected vehicle, helps them obtain new or add-on coverage and also offers a credit life insurance option to the purchaser. The major advantage is that the assisting party is the financier and the insurer, not merely an agent arranging for a third party financier or insurer.

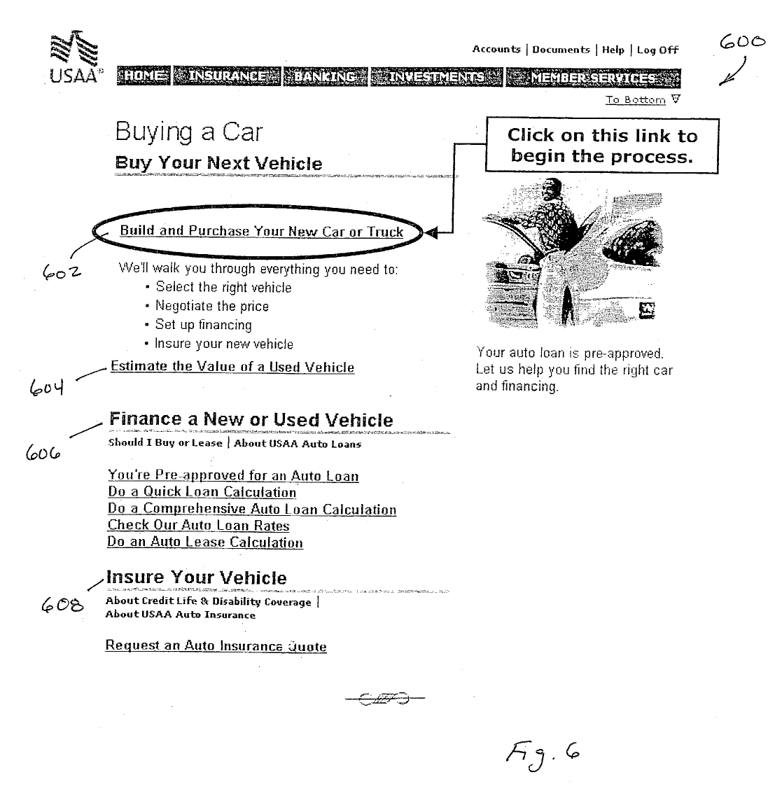

In the instance where the property item is a home, FIG. 4, the assisting party assists, at 400, in the buying 410, financing 420 and insuring 430 phases as an acquisition.

During the buying phase 410, the assisting party assists the purchaser in determining whether they should rent or buy, if qualified, and if so, assistance is provided in locating a real estate agent, if necessary.

During the financing phase 420, assistance is provided in calculating affordability, down payment and loan payment. Assistance is provided in checking mortgage rates and terms and whether the purchaser is a qualified buyer. Assistance is also provided in applying for a mortgage and mortgage approval.

In the insuring phase 430, assistance is provided in providing insurance quotes, purchasing homeowners or renters insurance and purchasing mortgage life insurance. The major advantage is that the assisting party is the mortgagor and the insurer, not merely an agent arranging for a third party mortgager or insurer.

Also, additional assistance is provided in purchasing a home security system at 431, and an appliance warranty at 432, however, such additional coverage is provided through a third party company.

In one embodiment, FIG. 5, information is accessed by means of a computer system 500 accessing a website 502 of the assisting party via the Internet 504. The computer system 500 includes a microprocessor 501, which is connected to a bus 503. Bus 503 serves as a connection between microprocessor 501 and other components of computer system 500. An input device 505 is coupled to microprocessor 501 to provide input to microprocessor 501. Examples of input devices include keyboards, touchscreens, and pointing devices such as mouses, trackballs and trackpads. Programs and data are stored on a mass storage device 507, which is coupled to microprocessor 501. Mass storage devices include such devices as hard disks, optical disks, magneto-optical drives, floppy drives and the like. Computer system 500 further includes a display 509, which is coupled to microprocessor 501 by a video controller 511. A system memory 513 is coupled to microprocessor 501 to provide the microprocessor with fast storage to facilitate execution of computer programs by microprocessor 501. It should be understood that other busses and intermediate circuits can be deployed between the components described above and microprocessor 501 to facilitate interconnection between the components and the microprocessor.

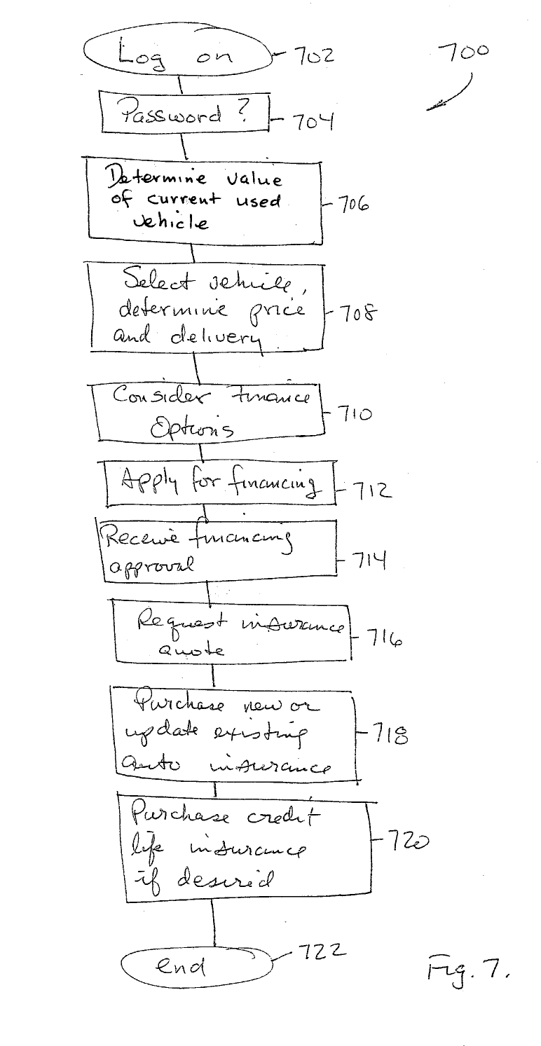

The website 502, FIG. 5, may offer a menu 600, FIG. 6, for purchasing a vehicle. The menu 600 may offer the ability to build and purchase a vehicle at 602, to estimate the value of a used vehicle at 604, to finance the vehicle at 606, and to insure the vehicle at 608. The website may be offered by a membership organization requiring a user password to log on, or may be a commercially available website.

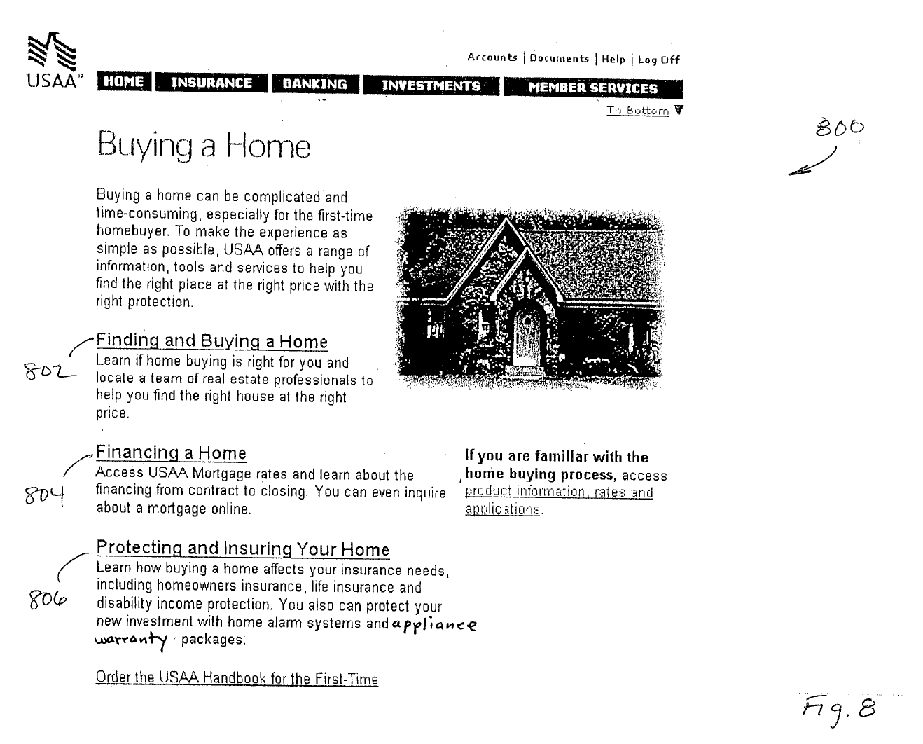

A flowchart for purchasing the vehicle is designated 700, FIG. 7, and begins with a log on to the website at 702, which may or may not require membership access and a password, at 704. It may be desired to determine the value of a current or used vehicle at 706. The new vehicle is selected, the price negotiated and delivery arrangements are determined at 708. The customer then considers finance options and terms at 710. A loan application is completed at 712 and is approval is provided at 714. The customer requests an auto insurance quote for the vehicle at 716, and purchases new or updates existing auto insurance at 718. Also, if desired, credit life insurance may be purchased at 720. The transaction is ended at 722. Each service, i.e., buy, finance and insure, is provided through the assisting party who not only provides assistance to the customer in locating and purchasing the vehicle, but the assisting party is also the financier and insurer of the vehicle.

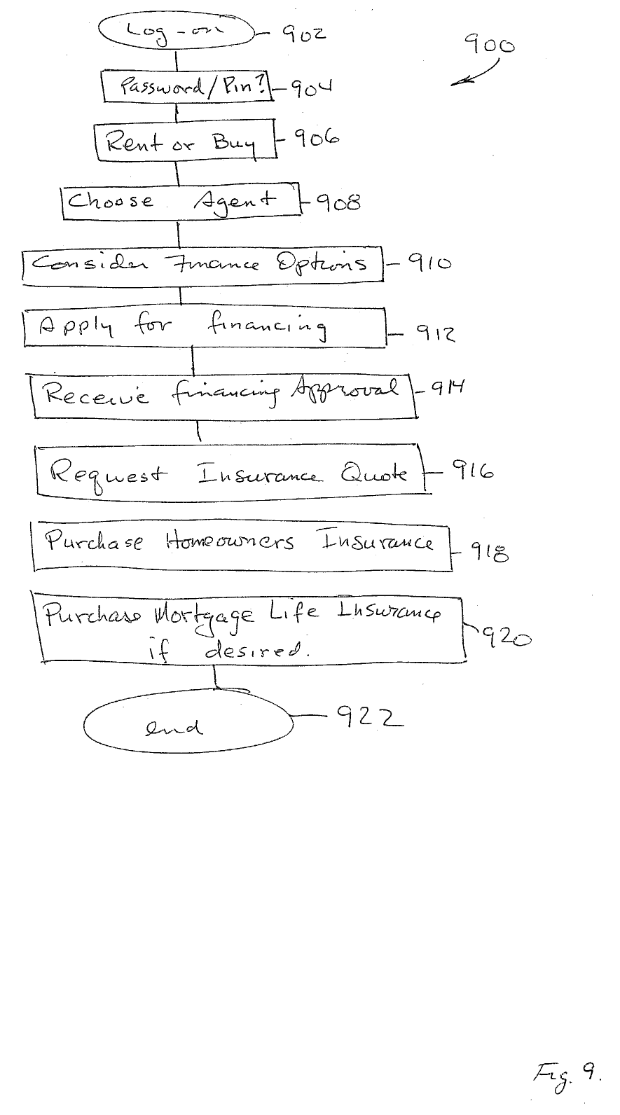

The website 502, FIG. 5, may offer a menu 800, FIG. 8, for purchasing a home. The menu 800 may offer the ability to find and buy a home at 802, to finance the home at 804, and to insure the home at 806.

A flowchart for purchasing the home is designated 900, FIG. 9, and begins with a log on to the website at 902, which may or may not require membership access and a password or pin number at 904.

The customer may inquire about renting or buying at 906. A real estate agent may be located at 908. The customer considers finance options at 910 and the various options are calculated and presented. A loan application is completed at 912 and approval is provided at 914. The customer requests an insurance quote at 916. Homeowner's insurance may be purchased at 918 and optional mortgage life insurance may be purchased at 920 if desired. The transaction is ended at 922. Each service, i.e., buy, finance and insure, is provided through the assisting party who not only provides assistance to the customer in locating and purchasing the home, but the assisting party is also the mortgagor and insurer of the home.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A method of acquiring property with the assistance of a single source comprising:
a user communicating with an assisting party for assistance in selecting a property item;
the user communicating with the assisting party for being financed for the property item by the assisting party; and
the user communicating with the assisting party for being insured for the property item by the assisting party.

2. The method as defined in claim 1 wherein the property item is an automotive vehicle.

3. The method as defined in claim 2 wherein the assisting party locates a specific vehicle.

4. The method as defined in claim 2 wherein the assisting party negotiates a price for the vehicle.

5. The method as defined in claim 2 wherein the assisting party determines a trade-in value of a vehicle to be traded by the user.

6. The method as defined in claim 2 wherein the assisting party provides financing options to the user.

7. The method as defined in claim 6 wherein the options include a loan, a lease and a balloon note.

8. The method as defined in claim 6 wherein the assisting party calculates a loan payment amount for the user.

9. The method as defined in claim 6 wherein the assisting party calculates a lease payment amount for the user.

10. The method as defined in claim 6 wherein the assisting party calculates a balloon payment amount for the user.

11. The method as defined in claim 2 wherein the assisting party provides an auto insurance quote for the vehicle.

12. The method as defined in claim 2 wherein the user purchases insurance from the assisting party for insuring the vehicle.

13. The method as defined in claim 2 wherein the assisting party provides a credit life insurance quote for the vehicle.

14. The method as defined in claim 7 wherein the assisting party provides a pre-approval amount for any one of the loan, lease and balloon note.

15. The method as defined in claim 1 wherein the property item is a residential property.

16. The method as defined in claim 15 wherein the assisting party provides rental and purchase options to the user.

17. The method as defined in claim 15 wherein the assisting party locates a real estate agent for the user.

18. The method as defined in claim 15 wherein the assisting party provides affordability and loan payment information to the user.

19. The method as defined in claim 15 wherein the assisting party provides mortgage rate options to the user.

20. The method as defined in claim 15 wherein the assisting party provides loan qualification information to the user.

21. The method as defined in claim 15 wherein the user applies for a mortgage to be provided by the assisting party.

22. The method as defined in claim 15 wherein the assisting party provides a renters insurance quote to the user.

23. The method as defined in claim 15 wherein the assisting party provides a homeowner's insurance quote to the user.

24. The method as defined in claim 23 wherein the assisting party provides a purchase life insurance quote to the user.

25. The method as defined in claim 15 wherein the assisting party provides a home security system option through a third party.

26. The method as defined in claim 15 wherein the assisting party provides an appliance warranty through a third party.

27. A method of acquiring, financing and insuring property with the assistance of a membership organization comprising:
a member communicating with the membership organization for assistance in selecting a property item;
the member further communicating with the membership organization for being financed for the property item by the membership organization; and
the member still further communicating with the membership organization for being insured for the property item by the membership organization.

28. A method of locating and acquiring property comprising:
a user communicating with an assisting party for assistance in locating a property item;
the user communicating with the assisting party for choosing selection options for the property item;
the user communicating with the assisting party for being financed for the property item by the assisting party; and
the user communicating with the assisting party for being insured for the property item by the assisting party.

29. A method of acquiring, financing and insuring property with the assistance of an organization comprising:
a customer communicating with the organization for assistance in selecting a property item;
the customer further communicating with the organization for being financed for the property item by the organization; and
the customer still further communicating with the organization for being insured for the property item by the organization.

30. A system for acquiring property with the assistance of a single source comprising:
a website maintained by an assisting party;
a computer system for accessing the website by a user comprising:
a chassis;
a microprocessor mounted in the chassis; and
a storage coupled to the microprocessor;
a user communicating with the assisting party for assistance in locating and selecting a property item;
the user communicating with the assisting party for being financed for the property item by the assisting party; and
the user communicating with the assisting party for being insured for the property item by the assisting party.

31. A method of offering a single source for assistance in locating, financing and insuring property item comprising:
the single source maintaining a website;
the single source receiving communication from a user for assistance in locating and selecting a property item;
the single source receiving communication from the user for being financed for the property item by the single source; and
the single source receiving communication from the user for being insured for the property item by the single source.
